(19) United States
(12) Patent Application Publication
(10) Pub. No.: US 2013/0114453 A1
(43) Pub. Date: May 9, 2013

(54) Method Applied to Receiver of Wireless Network for Frequency Offset and Associated Apparatus

(71) Applicant: MSTAR SEMICONDUCTOR, INC., Hsinchu Hsien (TW)

(72) Inventors: Shao-Ping Hung, Taipei City (TW); Tien-Hsin Ho, Zhubei City (TW); Tai-Lai Tung, Zhubei City (TW); Ching-Hsiang Chuang, New Taipei City (TW)

(73) Assignee: MSTAR SEMICONDUCTOR, INC., Hsinchu Hsien (TW)

(21) Appl. No.: 13/669,713

(22) Filed: Nov. 6, 2012

(30) Foreign Application Priority Data
Nov. 8, 2011 (TW) 100140751

(51) Int. Cl. H04W 24/00

(52) U.S. Cl. 370/252

(57) ABSTRACT

A method applied to a receiver of a wireless network in response to frequency offset is provided. Upon receiving a preamble, a reference symbol is provided according to a long training symbol in the preamble, and a frequency domain transform is performed on the reference symbol to generate a corresponding reference spectrum. A correlation calculation is performed on the reference spectrum and a predetermined spectrum to provide a first frequency offset. The preamble is carried by a plurality of different sub-carrier frequencies, with a frequency difference between neighboring sub-carrier frequencies being equal to a sub-carrier frequency space. The first frequency offset is an integral multiple of the sub-carrier frequency space.

This application claims the benefit of Taiwan application Serial No. 100140751, filed Nov. 8, 2011, the subject matter of which is incorporated herein by reference.

### BACKGROUND OF THE INVENTION

1. Field of the Invention

The invention relates in general to a method applied to a receiver of a wireless network in response to a frequency offset and an associated apparatus, and more particularly to a method applied to a receiver of a sub-carrier frequency division multiplexing wireless network to detect/compensate a frequency offset that is an integral multiple of a sub-carrier frequency space and associated apparatus.

2. Description of the Related Art

A wireless network is one of the most important networking techniques in the modern information society, as it is capable of interlinking, communicating and/or broadcasting packet, data, message, command, voice and audio streams. For wireless signals, frequency division multiplexing techniques that carry digital data by multiple sub-carrier frequencies continue to be a focus in the field of wireless networking. For example, wireless networks compliant with IEEE802.11a/g and 802.16 specifications are techniques that carry digital data through orthogonal frequency division multiplexing (OFDM).

To transmit data, command and/or messages from a transmitter of an ODFM wireless network, digital packets are formed through processes of coding and interweaving. In each packet, a plurality of bits are grouped and are respectively mapped to a constellation symbol of a constellation. The constellation symbol is represented as a complex number including a real part and an imaginary part. The constellation symbols are grouped according to a predetermined number to be respectively carried in a predetermined number of sub-carriers to form an OFDM symbol of a wireless signal, which is further transmitted to a receiver. That is, each constellation symbol corresponds to a sub-carrier, with the real part and the imaginary part respectively determining an amplitude and a positive/negative sign of an in-phase part and a quadrature-phase part of the corresponding sub-carrier.

Frequencies of the predetermined number of (multiple) sub-carriers are spread out from a center frequency and are thus different. The sub-carrier frequencies are also orthogonal from one another, with a frequency difference between two neighboring sub-carrier frequencies being referred to as a sub-carrier frequency space. For example, in the IEE802.11g specifications, the sub-carrier frequency space is 312.5 KHz.

Since the sub-carriers are orthogonal, an inverse frequency domain transform (e.g., Inverse Fast Fourier Transform (IFFT)) may be utilized to carry the predetermined number of constellation symbols by the corresponding sub-carriers. For example, the predetermined number of constellation symbols are inverse frequency domain transformed to obtain a time domain sequence. The time domain sequence is then converted to analog waveforms and mixed with an oscillation signal in the center frequency, so as to up-convert the time domain sequence to a wireless signal.

When the receiver of the wireless network receives via an antenna the wireless signal transmitted from the transmitter, the receiver appropriately amplifies the wireless signal, blends the amplified signal with a local oscillation signal, and filters the blended signal to down-convert the filtered signal to a low-frequency signal, e.g., an intermediate frequency (IF) or a baseband signal. The low-frequency signal is digitalized (e.g., sampled and/or analog-to-digital converted) to a time domain sequence, on which Fast Fourier Transform (FFT) is performed to obtain a frequency domain sequence. Through further digitally processing (e.g., inverse mapping of the constellation, decoding and inverse interweaving) the frequency domain sequence, packets are retrieved to restore the data, commands and/or messages that the transmitter wishes to transmit.

To correctly restore the bits in the packets at the receiver, the frequency of the local oscillation signal should match a common part of the sub-carrier frequencies, e.g., the center frequency. If the frequency of the local oscillation signal deviates from an intended ideal frequency, the signal exchange quality (e.g., a bit error rate) of wireless network is undesirably affected. Therefore, a detection and compensation mechanism needs to be established in the receiver in response to the frequency offset of the local oscillation signal to mitigate the undesirable effects imposed by the frequency offset.

In a wireless network, to keep the receiver well informed of various parameters of wireless signals and conditions of wireless channels in order to perform timing synchronization, gain control and channel estimation, a preamble is allocated to an initial part of a packet at the time when the packet is formed at the transmitter. For example, the preamble includes a plurality of (e.g., 10) short training symbols and a plurality of (e.g., 2) long training symbols. Contents of the short training symbols are identical, and contents of the long training symbols are also equal, so that the receiver can use the short training symbols and the long training symbols with known contents for detecting and compensating the frequency offset of the local oscillation signal. More specifically, coarse frequency offset estimation is carried out by used of the short training symbols, and fine frequency offset estimation is carried out by use of the long training symbols.

Nevertheless, the coarse frequency offset estimation and fine frequency offset estimation are only capable of detecting limited frequency offset. For a local oscillation frequency having a frequency offset that equals a sum of an integral multiple of the sub-carrier frequency space and a decimal part smaller than one sub-carrier frequency, the coarse frequency offset estimation and fine frequency offset estimation can only detect the decimal part of the frequency offset but cannot detect the frequency offset that is an integral multiple of the sub-carrier frequency space.

In the receiver, a frequency accuracy of the local oscillation signal is associated with the cost of the receiver. The frequency of the local oscillation signal needs to be more accurate as the detection capability and tolerance for the frequency offset get lower, all of which can only be achieved by higher costs, and yet the higher costs are unfavorable for promotion and applications of the wireless network.

### SUMMARY OF THE INVENTION

To increase the detection capability and tolerance for a large frequency offset in the receiver so that a wireless signal can still be accurately interpreted when the frequency offset is greater than a number of times of the sub-carrier frequency, the present invention is directed to a method for detecting/compensating a frequency offset that is an integral multiple of the sub-carrier frequency space and associated apparatus.

It is an objective of the present invention to provide a method applied to a receiver of a wireless network in response to a frequency offset in the receiver. The method comprises: upon receiving a preamble at the receiver, providing a reference symbol according to a long training symbol/long training symbols in the preamble, and performing a frequency domain transform on the reference symbol to generate a corresponding reference spectrum; and performing a correlation calculation on the reference spectrum and a predetermine spectrum to provide a first frequency offset. The wireless network is a multi-carrier frequency division multiplexing wireless network, e.g., an OFDM wireless network. Wireless signals of the wireless network, including the preamble, are carried by a plurality of different sub-carrier frequencies. A frequency difference between neighboring sub-carrier frequencies is a sub-carrier frequency space, and the first frequency offset is an integral multiple of the sub-carrier frequency space.

The preamble includes in sequence a plurality of short training symbols, a first long training symbol and a second long training symbol. A first delay correction is performed on the short training symbols to provide a second frequency offset (i.e., a coarse frequency offset), which is smaller than the first frequency offset. When the coarse frequency offset is obtained from the short training symbols, the first long training symbol, the second long training symbol and other frequency division multiplexing symbols (e.g., OFDM) symbols in the packet are compensated according to the coarse frequency offset.

In an embodiment of the present invention, the reference symbol is provided according to the first long training symbol, and the first long training symbol compensated according to the coarse frequency offset is utilized as the reference symbol to obtain the frequency offset that is an integral multiple of the sub-carrier frequency space according to the correlation calculation. Meanwhile, a second delay correction is performed on the first long training symbol and the second long training symbol compensated according to the coarse frequency offset to provide a third frequency offset (i.e., a fine frequency offset). Next, after receiving the other frequency division multiplexing symbols following the preamble, the frequency division multiplexing symbols are compensated according to the fine frequency offset and the frequency offset that is an integral multiple of the sub-carrier frequency space. The fine frequency offset is smaller than the coarse frequency offset.

In another embodiment of the present invention, the reference symbol is provided according to a signal sum of the first long training symbol and the second long training symbol. That is, the first long training symbol and the second long training symbol compensated according to the coarse frequency offset are added to provide the reference symbol, and the frequency offset that is an integral of the sub-carrier frequency is obtained based on the correlation calculation. Meanwhile, the second delay correction is performed on the first long training symbol and the second long training symbol compensated according to the coarse frequency offset to provide the third frequency offset (i.e., a fine frequency offset). Next, after receiving the other frequency division multiplexing symbols following the preamble, the frequency division multiplexing symbols are compensated according to the coarse frequency offset, the fine frequency offset and the frequency offset that is an integral multiple of the sub-carrier frequency space.

In an embodiment, the correlation calculation comprises: changing an offset between the reference spectrum and the predetermined spectrum, providing a corresponding correlation coefficient for the offset according to a sum of products of the reference spectrum and the predetermined spectrum based on the changed offset, and comparing the correlation coefficients corresponding to the different offsets to provide a first frequency offset.

It is another objective of the present invention to provide an apparatus applied to a receiver of a wireless network in response to a frequency offset of a local oscillation signal in the receiver. The apparatus comprises a reference symbol module, a frequency domain transform module, first, second and third frequency offset estimation modules, and a compensation module. When the receiver receives a preamble, the reference symbol module provides a reference symbol according to the preamble. The frequency domain transform module performs a frequency domain transform on the reference symbol to generate a corresponding reference spectrum. The first frequency offset estimation module performs a correlation calculation on the reference spectrum and a predetermined spectrum to provide a first frequency offset, which is an integral multiple of a sub-carrier frequency space.

The second frequency offset estimation module performs a first delay correction calculation on short training symbols in the preamble to provide a second frequency offset, which is smaller than the first frequency offset.

The third frequency offset estimation module performs a second delay correlation calculation on a plurality of long training symbols in the preamble to provide a third frequency offset, which is smaller than the second frequency offset.

The compensation module compensates the first long training symbol, the second long training symbol and other subsequent frequency division multiplexing symbols according to the second frequency offset. The reference symbol module provides the reference symbol according to at least one of the long training symbols. In an embodiment, the reference symbol module provides the reference symbol according to the first long training symbol compensated by the second frequency offset. In another embodiment, the reference symbol module provides the reference symbol according to a signal sum of the plurality of long training symbols compensated by the second frequency offset.

When the receiver receives the preamble and the subsequent frequency division multiplexing symbols, the compensation module compensates the subsequent frequency division multiplexing symbols according to the first, second and third frequency offsets.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a timing diagram depicting a preamble in a time domain signal packet in a wireless network.

FIG. 2 is a schematic diagram illustrating frequency offset estimation according to a delay correlation calculation.

FIG. 3 is a schematic diagram of frequency offset detection for detecting a frequency offset that is an integral multiple of a sub-carrier frequency space according to an embodiment of the present invention.

FIG. 4 is an operating mechanism for realizing the frequency offset detection in FIG. 3 according to an embodiment of the present invention.

FIG. 5 is a schematic diagram of an apparatus for detecting and compensating a frequency offset of a local oscillation signal in a receiver of a wireless network according to an embodiment of the present invention.

### DETAILED DESCRIPTION OF THE INVENTION

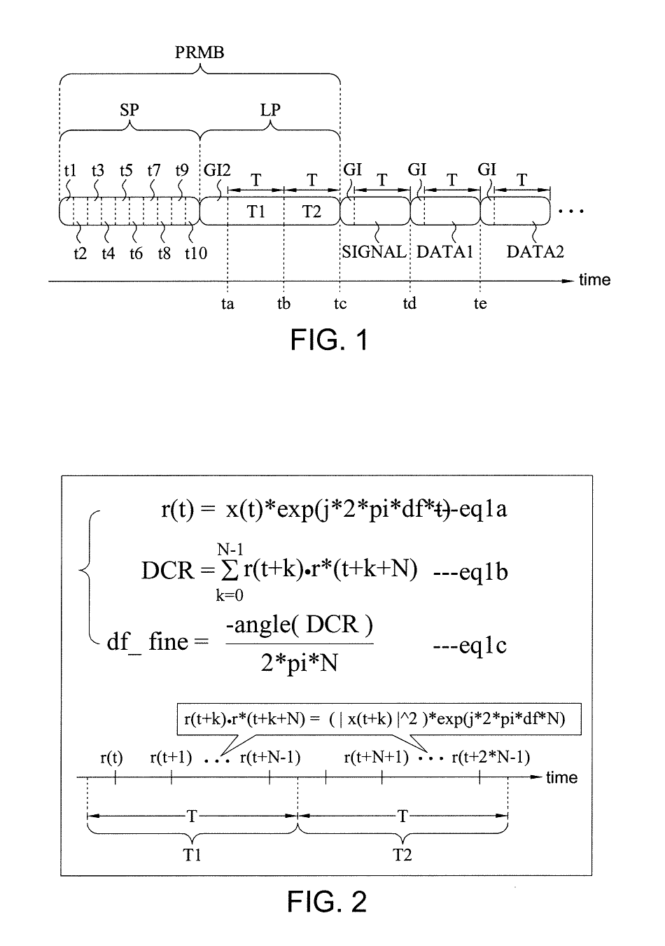

FIG. 1 shows a timing diagram depicting a preamble in a time domain signal packet in a wireless network. For example, the wireless signal is an OFDM wireless signal including a preamble PRMB, which includes a short preamble SP and a long preamble LP. In sequence, the short preamble SP includes ten short training symbols t1 to t10, and the long preamble LP includes a guard interval GI2 and two long training symbols T1 and T2. Following the preamble PRMB are subsequent frequency division multiplexing symbols (e.g., OFDM symbols) and a corresponding guard interval GI. For example, the subsequent frequency division multiplexing symbols are SIGNAL, DATA1 and DATA2. The long training symbol T1 begins at a time point to and ends at a time point tb. The long training symbol T2 beings at the time point tb and ends at a time point tc. The subsequent guard interval GI and the frequency division multiplexing SIGNAL are arranged in order between time points tc and td, and the next guard interval GI and the frequency division multiplexing DATA1 are arranged in order between time points td and te, and so forth.

The long training symbols T1 and T2 have a duration equal to those of the subsequent frequency division multiplexing symbols, i.e., a duration T. A duration of the short training symbols t1 to t10 may equal to ¼ of the duration T, a duration of the guard interval GI may equal to the duration of one short training symbol, and a duration of the guard interval GI2 may equal twice that of the guard interval GI.

The short training symbols t1 to t10 have the same contents. In a period between the short training symbols t1 to t7, a receiver (not shown) may perform signal detection, automatic gain control and diversity selection by use of the short training symbols. In a period between the short training symbols t8 to t10, a coarse frequency offset estimation is performed to obtain a coarse frequency offset. Within the duration of the long preamble LP, a fine frequency offset estimation is performed according to the long training symbol T1 (and/or the training symbol T2) to obtain a fine frequency offset.

When the long preamble LP ends at the time point tc, the receiver may compensate a frequency offset of a local oscillation signal according to the estimated frequency offsets. Provided that the frequency offsets are correctly detected and compensated, between the time points tc and td, the receiver may then further read parameters (columns) associated with signal exchange such as packet rate and length. The receiver reads the service column of the packet between the time points td and te to start retrieving data carried in the packet.

FIG. 2 shows a schematic diagram of a fine frequency offset estimation performed based on the long training symbols T1 and T2 according to an embodiment of the present invention. When the wireless signal received by the receiver is down-converted to the low-frequency signal via the local oscillation signal, the long training symbol T1 is sampled as N number of samples r(t), r(t+1) to r(t+N−1), and the long training symbol T2 is sampled as N number of samples r(t+N) to r(t+22*N−1). A frequency offset df between the local oscillation signal frequency fc_L and the transmitter center frequency fc_TX is set as df, and therefore fc_TX=fc_L+df. Thus, a random sample r(t+k) is represented as x(t+k)*exp(j*2*pi*df*(t+k)), or as shown by Equation eq1a. The sample x(t+k) represents an ideal sample obtained from the long training symbols T1 and T2 when the local oscillation signal frequency fc_L equals the transmitter center frequency fc_TX, the sample r(t+k) represents an actual sample under the influence of the frequency offset df, j is a square root of (−1), pi is the circumference rate, and exp(.) is an index function.

Since the contents of the long training symbols T1 and T2 are the same, a random sample r(t+k) from the long training symbol T1 is also identical (or extremely similar) to a sample r(t+k+N) from the long training symbol T2. Thus, a product of the complex conjugates of the sample r(t+k) and the sample r(t+k+N) equals |x(t+k)|*exp(−j*2*pi*df*N). In other words, an angle between the real part and the imaginary part of the product is (−2*pi*df*N)+(2*pi*M), where M is an integer. By dividing the angle by (−2*pi*N), a fine frequency offset may be obtained accordingly. In FIG. 2, Equations eq1b and eq1c are for obtaining a fine frequency offset df_fine according to the discussion above. In the Equation eq1b, a delay correlation coefficient DCR is a result obtained by performing a delay correlation calculation on the long training symbols T1 and T2, and a function angle(z) is for calculating the angle between the real part and the imaginary part of a complex number z.

Based on the same principles, i.e., the contents of the short training symbols are the same, a coarse frequency offset df_coarse may be obtained according to a delay correlation calculation in FIG. 2. Since the duration of the short training symbols are shorter than that of the long training symbols, the number of samples of each short training symbol is smaller so that the coarse frequency offset df_coarse is greater than the fine frequency offset df_fine.

However, the coarse frequency offset estimation and the fine frequency offset estimation are only capable of detecting limited frequency offset. The local oscillation signal frequency offset df is represented as df=K*Kfss+df_fraction, where Dfss is the sub-carrier frequency space, K is an integer, K*Dfss is thus the frequency offset that is an integral multiple of the sub-carrier frequency space Dfss, and df_fraction is the frequency offset smaller than the sub-carrier frequency Dfss. The coarse frequency offset df_coarse and the fine frequency offset df_fine respectively obtained from the coarse frequency offset estimation and the fine frequency offset estimation only cover the frequency offset df_fraction that is only a part of the frequency offset df but are incapable of detecting the frequency offset of K*Dfss.

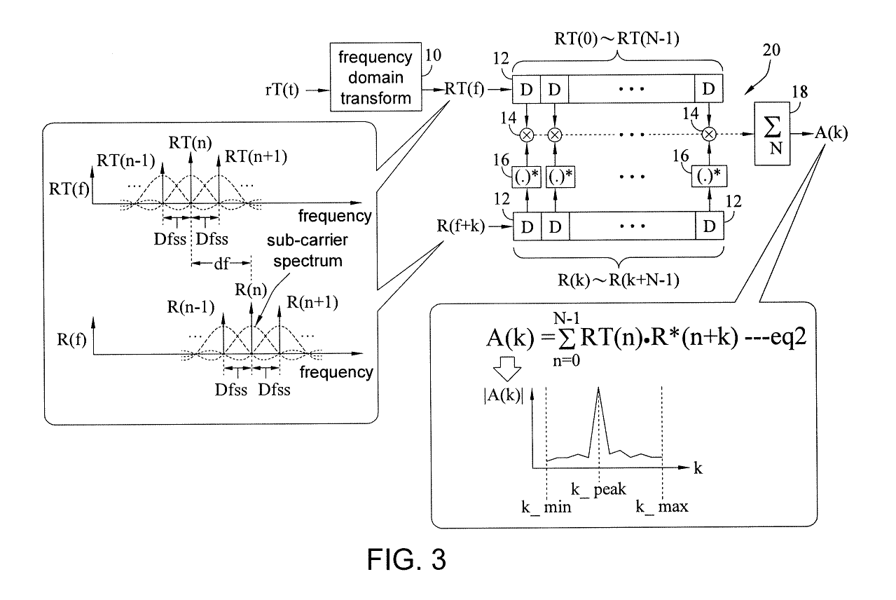

FIG. 3 shows a schematic diagram of a frequency offset detection for detecting the frequency offset K*Dfss that is an integral multiple of the sub-carrier frequency space according to an embodiment of the present invention. A reference symbol rT(t) is formed according to the long training symbols T1 and/or T2 received by the receiver. By performing a frequency domain transform 10 on the reference symbol rT(t), a corresponding reference spectrum RT(f) is obtained. For example, FFT is performed on N number of time domain sequence samples rT(0) to rT(N−1) of the reference symbol rT(t) to obtain samples RT(0) to RT(N−1) of the reference spectrum RT(f), as shown in FIG. 3.

In an embodiment, the reference symbol rT(t) may be obtained according to the long training symbol T1. That is, the sample rT(n) of the reference symbol rT(t) may be obtained according to the sample r(t+n) of the long training symbol T1 (in FIG. 2). For example, the sample rT(n) is rT(n)=r(t+n)*exp(−j*2*pi*df_coarse), where n equals 0 to (N−1). The long training symbols T1 and T2 are arranged after the short training symbols, and so after carrying out the coarse frequency offset estimation by use of the short training symbols, the long training symbols T1 and T2 may be compensated according to the coarse frequency offset df_coarse (i.e., being multiplied by exp(−j*2*pi*df_coarse)). The long training symbol T1 compensated by the coarse frequency offset and then serves as the reference symbol rT(t).

In another embodiment, the reference symbol rT(t) is provided according to a signal sum of the long training symbols T1 and T2. For example, the sample rT(n) is synthesized from the long training symbols T1 and T2: rT(n)=[a1*r(t+n)+a2*r(t+n+N)]*exp(−j*2*pi*df_coarse), where n equals 0 to (N−1). The sample r(t+n+N) is a sample of the long training symbol T2 as shown in FIGS. 2; a1 and a2 are constants, e.g., a1=a2=1. That is, after compensating the long training symbols T1 and T2 according to the coarse frequency offset df_coarse, the signal sum of the long training symbols T1 and T2 compensated by the coarse frequency offset may be utilized as the reference symbol rT(t).

The contents of the long training symbols T1 and T2 are identical and known, and respectively carry the constellation symbols R(0) to R(N−1) by N number of sub-carriers. According to wireless network protocols, the receiver is allowed to in advance be informed of the constellation symbols R(0) to R(N−1). The constellation symbols R(0) to R(N−1) may be regarded as frequency domain samples of a predetermined spectrum R(f). The predetermined spectrum R(f) in the time domain corresponds to the time domain samples x(t) in FIG. 2, which is an ideal sample of the long training symbols T1 and T2 under zero frequency offset. In contrast, the reference spectrum RT(f) corresponds to the long training symbols T1 and T2 actually received by the receiver. From Equation eq1a, the frequency offset K*Dfss that is an integral multiple of the sub-carrier frequency space renders the frequency domain sample RT(n)=R(n−K). That is, the integral K is to be obtained when detecting the frequency offset K*Dfss at the receiver. Therefore, a correlation calculation 20 is to be performed on the reference spectrum Rf(f) and the predetermined spectrum R(f) in the present invention to obtain the value of the integral K.

As shown by Equation eq2 in FIG. 3, the correlation calculation 20 changes an offset k (e.g., an integral) between a reference spectrum sample Rf(n) and a predetermined spectrum sample R(n+k), and provides a corresponding correlation coefficient A(k) for the offset k according to a sum of respectively products of the complex conjugates and the sample Rf(n) and the sample R(n+k). The correlation calculation 20 includes a delay operation 12, a multiplication operation 14 and a conjugate operation 16. The correlation calculation 20 is performed on a plurality of different offsets k to obtain a plurality of correlated coefficients A(k). For example, for all integral offsets k smaller than an integral constant k_max and greater than another integral constant k_min (k_min may equal −k_max), corresponding coefficients A(k) are respectively obtained. The correlation coefficients A(k) corresponding to different offsets k are compared to obtain a peak correlation coefficient A(k_peak) of the correlation coefficient A(k). According to the offset k_peak corresponding to the peak coefficient A(k_peak), the integer K in the frequency offset K*Dfss is obtained. Thus, the frequency offset that an integral multiple of the sub-carrier frequency space is detected to repair the shortcomings of the coarse and fine frequency offsets.

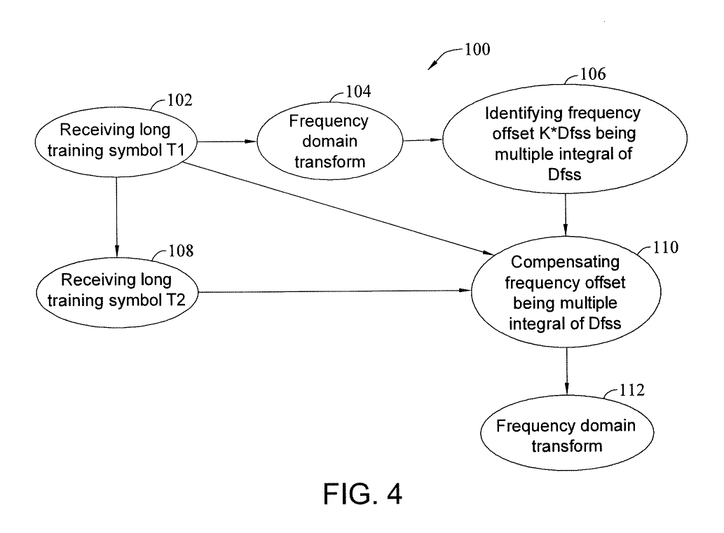

When the frequency offset that is an integral multiple of the sub-carrier frequency space is detected, compensation may be performed. An operating mechanism 100 that performs detection and compensation according to the frequency offset that is an integral multiple of the sub-carrier frequency space according to an embodiment of the present invention is illustrated in FIG. 4. The operating mechanism 100 comprises steps below.

In Step 102, the long training symbol T1 in the long preamble LP is received (FIG. 2).

In Step 104, a frequency domain transform is performed on the reference symbol rT(t) formed according to the long training symbol T1 to obtain the corresponding reference spectrum RT(f). For example, FFT is performed on the time domain sequence sample of the reference symbol rT(t) to obtain the frequency domain sequence sample RT(n) of the reference spectrum RT(f).

In Step 106, the frequency domain offset K*Dfss that is an integral multiple of the sub-carrier frequency space Dfss is identified through the correlation calculation 20 in FIG. 3.

In Step 108, the long training symbol T2 in the long preamble LP is received.

In Step 110, according to the detected frequency offset that is an integral multiple of the sub-carrier frequency space, frequency offsets of the subsequent frequency division multiplexing symbols (e.g., the frequency division multiplexing symbols SIGNAL, DATA1 and DATA2 in FIG. 1) following the long training symbol T2 are compensated.

In Step 112, a frequency domain transform is performed on the compensated frequency division multiplexing symbols to correctly retrieve information carried by the frequency domain, e.g., channel estimation information, commands, messages and data.

In an embodiment, an operating timing of the operating mechanism 100 is illustrated below with reference to FIG. 1. After the time point ta, the coarse frequency offset df_coarse is detected according to the short training symbols t1 to t10, and thus the frequency division multiplexing symbols (including the long training symbols T1 and T2 as well as the frequency division multiplexing symbols SIGNAL, DATA1 and DATA2) after the time point ta may be compensated according to the coarse frequency offset df_coarse. Between the time points tb and tc, the reference symbol is formed according to the received (and compensated according to the coarse frequency offset) long training symbol T1, and the reference symbols is frequency domain transformed as in Step 104, so as to detect the frequency offset that is an integral multiple of the sub-carrier frequency space in Step 106. Further, after the time point tc, based on the principles in FIG. 2, the fine frequency offset df_fine is detected according to the received (and compensated according to the coarse frequency offset) long training symbols T1 and T2. Therefore, after the time point tc, the coarse frequency offset df_coarse, the frequency offset K*Dfss that is an integral multiple of the sub-carrier frequency space, and the fine frequency offset df_fine are all detected. From the above three offsets, the total frequency offset df=df_coarse+K*Dfss+df_fine is completely detected to accordingly compensate the frequency division multiplexing symbols after the time point tc. For example, the signal rs(t) received by the receiver is compensated according to xs(t)=rs(t)*exp(−j*2*pi*df*t), wherein the signal xs(t) is the signal after frequency offset compensation. By performing a frequency domain transform on the signal xs(t), the messages, data and commands carried in the signal xs(t) may be corrected retrieved.

In another embodiment, the frequency offset is detected and compensated according to the timing below. After the time point ta, the coarse frequency offset df_coarse is detected to accordingly compensate the subsequently received frequency division multiplexing symbols. After the time point tc, the reference symbols is synthesized from the signal sum of the received (and compensated according to the coarse frequency offset) long training symbols T1 and T2, so as to detect the frequency offset that is an integral multiple of the sub-carrier frequency space in Step 106. Meanwhile, after the time point tc, based on the principles in FIG. 2, the fine frequency offset df_fine is also detected according to the received (and compensated according to the coarse frequency offset) long training symbols T1 and T2. Therefore, after the time point tc, the coarse frequency offset df_coarse, the frequency offset K*Dfss that is an integral multiple of the sub-carrier frequency space, and the fine frequency offset df_fine are all detected, so as to accordingly compensate the frequency division multiplexing symbols after the time point tc. The reference symbol synthesized form the sum of the long training symbols T1 and T2 is capable of reducing undesirable effects that signal noises have on the frequency offset estimation.

In an embodiment, when compensating the frequency offset that is an integral multiple of the sub-carrier frequency space, the compensation is carried out in the time domain; that is, the received signal is multiplied by exp(−j*2*pi*K*Dfss*t). In another embodiment, the received signal is frequency domain transformed, and the compensation is carried out in the frequency domain; that is, the frequency domain sequence samples of the received signal are frequency domain transformed to compensated frequency domain sequence samples. It is known from Equation eq1a that, for the received signal rs(t), the frequency offset K*Dfss that is an integral multiple of the sub-carrier frequency space renders the frequency domain sample Rs(n) of the signal rs(t) equal to the sample Xs(n−K), where time domain signal xs(t) corresponding to the frequency domain sample Xs(n) is the result from compensating the frequency domain offset that is the integral multiple of the sub-carrier frequency space. Therefore, after the integral K is detected in FIG. 3, the sample Rs(n) are frequency domain shifted, so that the correct frequency domain sample Xs(n) may also be obtained from the frequency domain shifted samples Rs(n+K).

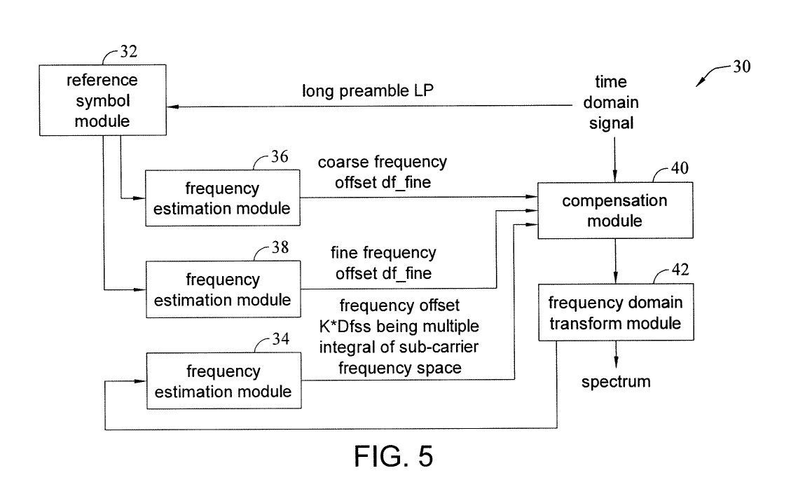

FIG. 5 shows a schematic diagram of an apparatus 30 according to an embodiment of the present invention. The apparatus 30 is applied to a receiver (not shown) of a wireless network in response to a frequency offset of the receiver. The apparatus 30 comprises a reference symbol module 32, a frequency domain transform module 42, frequency offset estimation modules 34, 36 and 38 (first, second and third frequency offset estimation modules, respectively), a compensation module 40, and a frequency domain transform module 42. The apparatus 30 interprets a time domain signal received by the receiver. For example, the time domain signal is a series of time domain samples that are down-converted by a local oscillation signal and digitalized. The compensation module 40 compensates a frequency offset of the local oscillation signal. The frequency domain transform module 42 performs a frequency domain transform on the compensated time domain signal to obtain a corresponding spectrum, e.g., FFT is performed on a plurality of time domain samples to generate a same number of corresponding frequency domain samples. Accordingly, data, messages and/or commands carried by the frequency domain may be retrieved.

When the receiver receives the preamble PRMB (FIG. 1), the reference symbol module 32 provides the reference symbol rT(t) (FIG. 3) according to the long preamble LP in the preamble PRMB. In an embodiment, the reference symbol module 32 provides the reference symbol according to one of the long training symbols. In another embodiment, the reference symbol module 32 provides the reference symbol according to a signal sum of a plurality of long training symbols. The frequency domain transform module 42 performs a frequency domain transform on the reference symbol rT(t) to generate the corresponding reference spectrum RT(f). The frequency offset estimation module 34 performs the correlation calculation in FIG. 3 on the reference spectrum RT(f) and a predetermined spectrum R(f) to accordingly provide the first frequency offset, which is an integral multiple of the sub-carrier frequency space.

The frequency offset estimation module 34 performs a delay correlation calculation on the long training symbols T1 and T2 in the preamble PRMB to provide the fine frequency offset df_fine, as shown in FIG. 2. Similarly, the frequency offset estimation module 36 performs a delay correlation calculation on the short training symbols in the preamble PRMB to provide the coarse frequency offset df_coarse. The fine frequency offset df_fine is smaller than the coarse frequency offset df_coarse, and both are smaller than the frequency offset K*Dfss that is an integral multiple of the sub-carrier frequency space.

The compensation module 40 compensates the long training symbols T1 and T2 as well as other subsequent frequency division multiplexing symbols according to the coarse frequency offset df_coarse. When the frequency division multiplexing symbols after the preamble PRMB are received by the receiver, the compensation module 40 compensates the subsequent frequency division multiplexing symbols according to the coarse and fine frequency offsets as well as the frequency offset that is an integral multiple of the sub-carrier frequency space.

The modules in FIG. 5 may be realized by software, hardware and/or firmware. For example, the frequency domain transform module 42 is a hardware module, and functions of the frequency offset estimation module 34 may be realized through executing corresponding codes by a processor (not shown). The apparatus 30 may be integrated in a baseband integrated circuit of the receiver.

In conclusion, compared to the conventional coarse and fine frequency offset estimations, the prevent invention is capable of further detecting and compensating the frequency offset that is an integral multiple of the sub-carrier frequency space in the receiver of the frequency division multiplexing wireless network. Therefore, the present invention is capable of compensating while having a higher tolerance for a local oscillation signal generated by a lower cost, thereby at the same time reducing the cost of the receiver to favor promotions and applications of the wireless network.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method, applied to a receiver of a wireless network, for detecting a frequency offset, the method comprising:
upon receiving a preamble by the receiver, providing a reference symbol according to the preamble;
performing a frequency domain transform on the reference symbol to generate a corresponding reference spectrum; and
correlating the reference spectrum with a predetermined spectrum to provide a first frequency offset;
wherein, the preamble is carried by a plurality of sub-carrier frequencies, a sub-carrier frequency space represents a frequency difference between neighboring sub-carrier frequencies, and the first frequency offset is an integral multiple of the sub-carrier frequency space.

2. The method according to claim 1, wherein the preamble comprises a first long training symbol and a second long training symbol, and the reference symbol is provided according to the first long training symbol.

3. The method according to claim 1, wherein the preamble comprises a plurality of long training symbols, and the reference symbol is provided according to a signal sum of the long training symbols.

4. The method according to claim 1, the preamble comprising a plurality of short training symbols, the method further comprising:
performing a first delay correlation calculation on the short training symbols to provide a second frequency offset;
wherein, the second frequency offset is smaller than the first frequency offset.

5. The method according to claim 4, the preamble further comprising a plurality of long training symbols, the method further comprising:
performing a second delay correlation calculation on the long training symbols to provide a third frequency offset;
wherein, the reference symbol is provided according to at least one of the long training symbols.

6. The method according to claim 5, wherein the third frequency offset is smaller than the second frequency offset.

7. The method according to claim 5, the long training symbols comprising sequentially arranged a first long training symbol and a second long training symbol, the method further comprising:
compensating the first long training symbol according to the second frequency offset, and accordingly providing the reference symbol.

8. The method according to claim 5, further comprising:
compensating the long training symbols according to the second frequency offset, and accordingly providing the reference symbol according to a signal sum of the compensated long training symbols.

9. The method according to claim 5, further comprising:
upon receiving a frequency division multiplexing symbol after the preamble, compensating the frequency division multiplexing symbol according to the third frequency offset and the first frequency offset.

10. The method according to claim 1, wherein the step of performing the correlation calculation comprises:
changing an offset between the reference spectrum and the predetermined spectrum, and providing a correlation coefficient according to a sum of products of the reference spectrum and the predetermined spectrum based on the changed offset; and
comparing the correlation coefficients corresponding to the different offsets to provide the first frequency offset.

11. The method according to claim 1, wherein the sub-carrier frequencies respectively correspond to a plurality of orthogonal frequency division multiplexing (OFDM) sub-carriers.

12. An apparatus, applied to a receiver of a wireless network, for detecting a frequency offset, the apparatus comprising:
a reference symbol module, for providing a reference symbol according to a preamble;
a frequency domain transform module, for performing a frequency domain transform on the reference symbol to generate a corresponding reference spectrum; and
a first frequency offset estimation module, for performing a correlation calculation on the reference spectrum and a predetermined spectrum to provide a first frequency offset;
wherein, the preamble is carried by a plurality of different sub-carrier frequencies, a sub-carrier frequency space represents a frequency difference between neighboring sub-carrier frequencies, and the first frequency offset is an integral multiple of the sub-carrier frequency space.

13. The apparatus according to claim 12, wherein the preamble comprises a first long training symbol and a second long training symbol, and the reference symbol module provides the reference symbol according to the first long training symbol.

14. The apparatus according to claim 12, wherein the preamble comprises a plurality of long training symbols, and the reference symbol module provides the reference symbol according to a signal sum of the long training symbols.

15. The apparatus according to claim 12, the preamble comprising a plurality of short training symbols, the apparatus further comprising:
a second frequency offset estimation module, for performing a first delay correlation calculation on the short training symbols to provide a second frequency offset;
wherein, the second frequency offset is smaller than the first frequency offset.

16. The apparatus according to claim 15, the preamble further comprising a plurality of long training symbols, the apparatus further comprising:
a third frequency offset estimation module, for performing a second delay correlation calculation on the long training symbols to provide a third frequency offset;
wherein, the reference symbol module provides the reference symbol according to at least one of the long training symbols.

17. The apparatus according to claim 16, wherein the third frequency offset is smaller than the second frequency offset.

18. The apparatus according to claim 16, the long training symbols comprising sequentially arranged a first long training symbol and a second long training symbol, the apparatus further comprising:
a compensation module, for compensating the first long training symbol according to the second frequency offset, and the reference symbol module accordingly provides the reference symbol.

19. The apparatus according to claim 16, further comprising:
a compensation module, for compensating the long training symbols according to the second frequency offset, and the reference symbol module provides the reference symbol according to a signal sum of the compensated long training symbols.

20. The apparatus according to claim 16, further comprising:
a compensation module, upon receiving a frequency division multiplexing symbol after the preamble, for compensating the frequency division multiplexing symbol according to the third frequency offset and the first frequency offset.
